(19) United States
(12) Patent Application Publication
(10) Pub. No.: US 2011/0163975 A1
(43) Pub. Date: Jul. 7, 2011

(54) TOUCH SCREEN STRUCTURE

(75) Inventors: JIANG-DONG LI, Shenzhen City (CN); JUN-JIE QIN, Shenzhen City (CN); HUI YUAN, Shenzhen City (CN)

(73) Assignees: HONG FU JIN PRECISION INDUSTRY(ShenZhen) CO., LTD., Shenzhen City (CN); HON HAI PRECISION INDUSTRY CO., LTD., Tu-Cheng (TW)

(21) Appl. No.: 12/820,071

(22) Filed: Jun. 21, 2010

(30) Foreign Application Priority Data
Jan. 4, 2010 (CN) 201010300021.7

(51) Int. Cl. G06F 3/041

(52) U.S. Cl. 345/173

(57) ABSTRACT

A touch screen includes a touch panel, adhesive layers, a display screen, a printed circuit board assembly and a spacer fixed between the touch panel and the display screen by the adhesive layers. The spacer includes a baseplate and a sidewall substantially perpendicularly extending from the periphery of the baseplate. The printed circuit board assembly is fixed on the sidewall of the spacer.

### BACKGROUND

1. Technical Field

The present disclosure relates to touch screen structures and, particularly, to a touch screen structure with a spacer.

2. Description of Related Art

Conventional touch screens include a touch panel, an adhesive layer, and a display screen. Touch panels are typically pasted on the display screen with the adhesive layer, thus, when users press the touch panel, the touch panel will press the display screen, and a ripple will appear on the display screen. Moreover, the display screen may be easily damaged by outside force.

Thus, what is needed is a touch screen structure with a spacer.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, isometric view of a touch screen structure according to an exemplary embodiment.

FIG. 2 is an exploded view of the touch screen structure of FIG. 1.

FIG. 3 is a schematic, isometric view of a spacer of the touch screen structure of FIG. 1.

FIG. 4 is a cross-sectional view of the touch screen structure of FIG. 1, taken along line IV-IV of FIG. 1.

### DETAILED DESCRIPTION

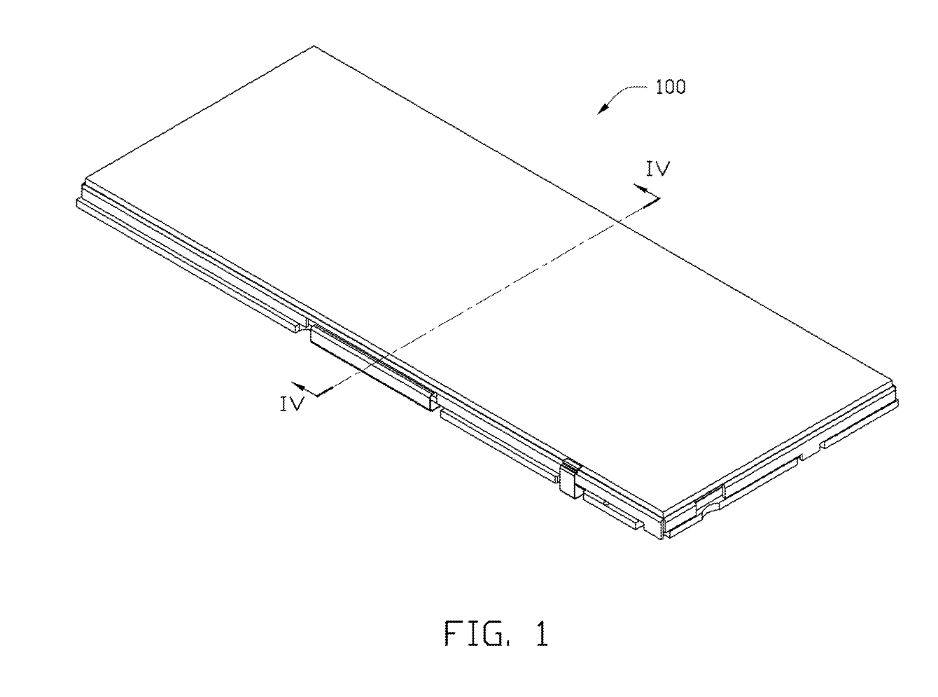

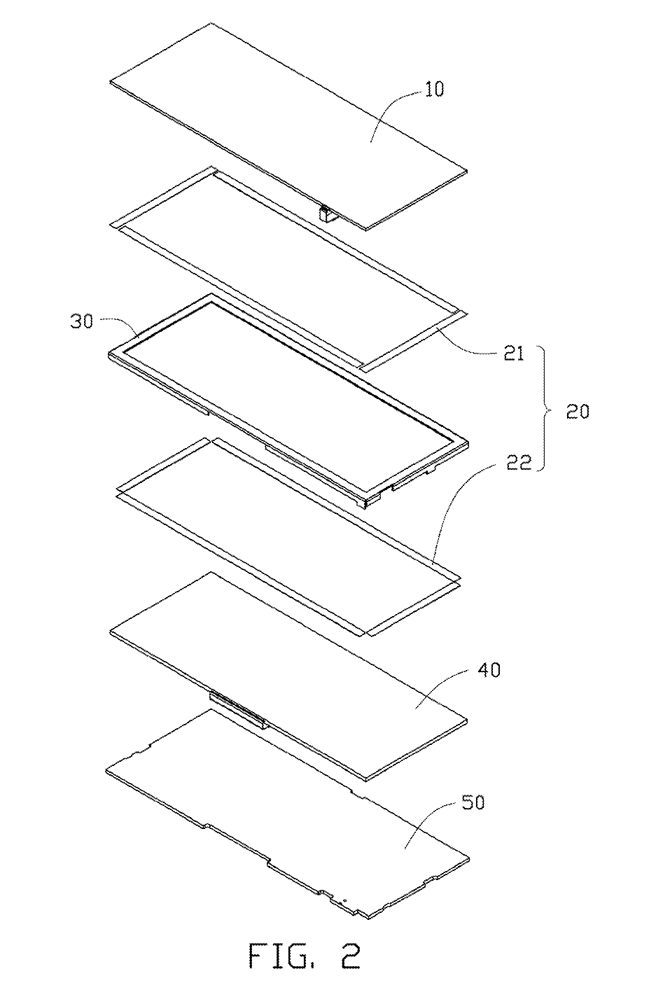

Referring to FIGS. 1 and 2, an isometric view of a touch screen 100 and an exploded view of the touch screen 100 according to an exemplary embodiment are disclosed. The touch screen 100 includes a touch panel 10, adhesive layers 20, a spacer 30, a display screen 40 and a printed circuit board assembly (PCBA) 50. The spacer 30 is placed between the touch panel 10 and the display screen 40 and is fixed on the PCBA 50. The touch panel 10 and the display screen 40 are fixed to the top side and the underside of the spacer 30 respectively.

The spacer 30 is a frame, and is made up of rigid metal material, and the thickness of the spacer 30 is in a range from about 0.3 mm to about 0.5 mm. The spacer 30 isolates the touch panel 10 from the display screen 40, when the touch panel 10 is pressed down, the touch panel 10 will not contact the display screen 40. In the embodiment, the spacer 30 is made of steel.

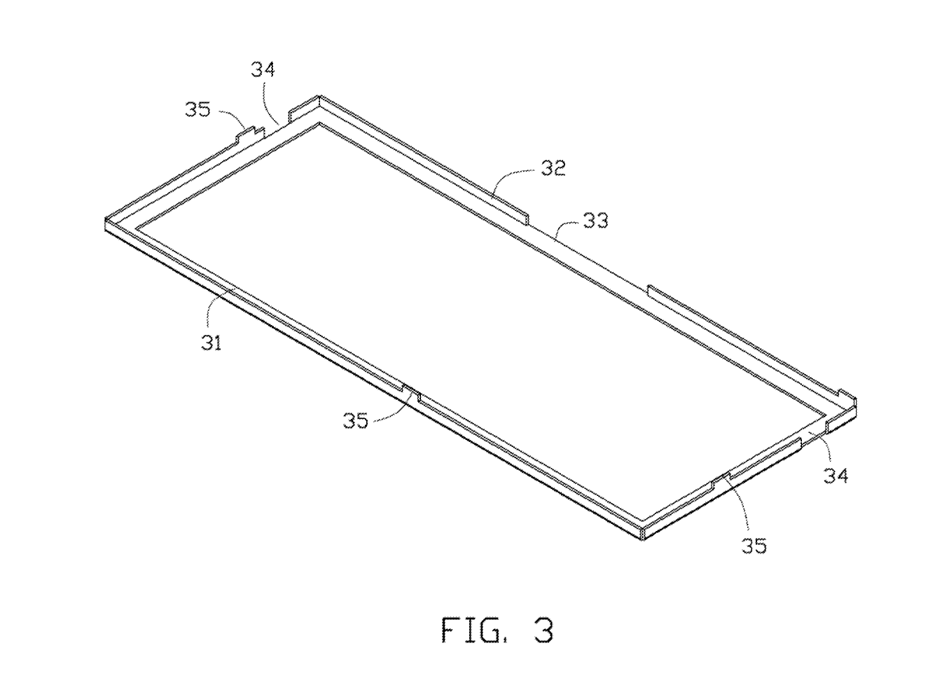

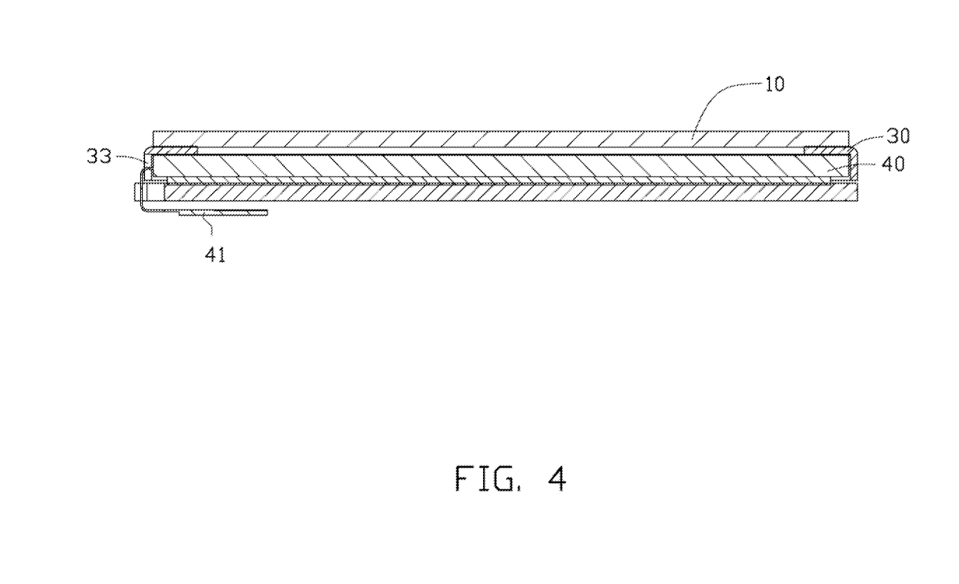

Referring also to FIGS. 3 and 4, the spacer 30 includes a baseplate 31 and a sidewall 32 substantially perpendicularly extending from the periphery of the baseplate 31. In the embodiment, the extending direction of the sidewall 32 is defined as an underside of the baseplate 31, and the reverse side is defined as a topside of the baseplate 31. The height of the sidewall 32 is consistent with the thickness of the display screen 40 for encasing the display screen 40 in the sidewall 32, thus, the display screen 40 is not easy to be damaged by external force. The sidewall 32 defines a plurality of slots 34 and flanges 35 matching with the PCBA 50 for fastening the spacer 30 to the PCBA 50. An opening 33 is defined at one side of the sidewall 32, a data wire 41 of the display screen 40 extends through the opening 33 and is connected to the PCBA 50.

Corresponding to the baseplate 31, the adhesive layers 20 are also frames, and the size of the adhesive layers 20 are not larger than that of the baseplate 31. In the embodiment, the thicknesses of the adhesive layers 20 are approximately 14 μm. The adhesive layers 20 are made of propylene or rubber, or the like material. The adhesive layers 20 include a first adhesive layer 21 and a second adhesive layer 22. The first adhesive layer 21 is placed between the touch panel 10 and the spacer 30 for sticking the touch panel 10 to the topside of the baseplate 31. The second adhesive layer 22 is placed between the spacer 30 and the display screen 40 for sticking the display screen 40 to the underside of the baseplate 31.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A touch screen structure comprising:
a touch panel;
a display screen;
a spacer positioned between the touch panel and the display screen, comprising a baseplate and a sidewall substantially perpendicularly extending from the periphery of the baseplate, the sidewall encasing the display screen;
adhesive layers configured for sticking the spacer on the touch panel and the display screen; and
a printed circuit board assembly fixed on the sidewall of the spacer.

2. The touch screen structure of claim 1, wherein the sidewall forms a plurality of slots and flanges, the slots and the flanges match with the printed circuit board assembly thereby fastening the spacer to the printed circuit board assembly.

3. The touch screen structure of claim 1, wherein an opening is defined at one side of the sidewall, a data wire of the display screen extends through out the opening to be connected with the printed circuit board assembly.

4. The touch screen structure of claim 1, wherein the height of the sidewall is consistent with the thickness of the display screen for encasing the display screen in the sidewall.

5. The touch screen structure of claim 1, wherein the spacer is a frame.

6. The touch screen structure of claim 1, wherein the spacer is made up of rigid metal material.

7. The touch screen structure of claim 1, wherein the adhesive layers are frames corresponding to the baseplate, and the size of the adhesive layers are not larger than that of the baseplate.

8. The touch screen structure of claim 1, wherein the adhesive layer comprises a first adhesive layer and a second adhesive layer, the first adhesive layer is placed between the touch panel and the spacer for sticking the touch panel on the topside of the baseplate; the second adhesive layer is placed between the spacer and the display screen for sticking the display screen on the underside of the baseplate.

9. A touch screen structure, comprising:
a touch panel;
a display screen;
a frame-shaped spacer positioned between the touch panel and the display screen, the space comprising a baseplate and a sidewall substantially perpendicularly extending from the periphery of the baseplate, the sidewall encasing the display screen, and the touch panel and the display screen being positioned on two opposite sides of the baseplate; and
a printed circuit board assembly positioned on the sidewall of the spacer and electrically connected to the display screen.

10. The touch screen structure of claim 9, further comprising a first adhesive layer and a second adhesive layer, the first adhesive layer sticking the touch panel on the baseplate, and the second adhesive layer sticking the display screen on the baseplate.

11. The touch screen structure of claim 9, wherein the sidewall defines a plurality of slots and forms a plurality of flanges, the slots and the flanges match with the printed circuit board assembly thereby fastening the spacer to the printed circuit board assembly.

12. The touch screen structure of claim 9, wherein an opening is defined in one side of the sidewall, a data wire extends through the opening and electrically connects the printed circuit board assembly to the display screen.

13. The touch screen structure of claim 9, wherein the height of the sidewall is consistent with the thickness of the display screen for encasing the display screen in the sidewall.

14. The touch screen structure of claim 9, wherein the spacer is made up of steel.

15. The touch screen structure of claim 9, wherein the thickness of the spacer is in a range from about 0.3 mm to about 0.5 mm.
